(19) United States
(12) Patent Application Publication
(10) Pub. No.: US 2007/0016963 A1
(43) Pub. Date: Jan. 18, 2007

(54) PIN entry terminal having security system

(75) Inventor: Carl W. Robinson, Charlotte, NC (US)

Correspondence Address: OLIFF & BERRIDGE, PLC, P.O. BOX 19928, ALEXANDRIA, VA, 22320, US

(73) Assignee: XAC AUTOMATION CORP., Hsinchu (TW)

(21) Appl. No.: 11/180,571

(22) Filed: Jul. 14, 2005

(51) Int. Cl. G06F 11/00

(52) U.S. Cl. 726/34

(57) ABSTRACT

A PIN entry terminal comprises an interface board, tamper resistant boards and a main board. The tamper resistant boards tightly enclose the main board. There is a plurality of solder joints between each adjacent two of the tamper resistant boards and the main board. Furthermore, an electrical connector electrically connects and is placed between the interface board and the main board. A tamper detection circuit through the solder joints and the electrical connector is provided in part on the tamper resistant boards, in part on the interface board and in part on the main board. If the interface board or the main board is disconnected from the electrical connector or one of the tamper resistant boards is tampered with, the tamper detection circuit is triggered.

### BACKGROUND OF THE INVENTION

1. Field of the Invention

The present invention relates to a PIN (personal identification number) entry terminal having a security system, and more particularly, to a security system for a PIN entry terminal to prevent any intrusion.

2. Description of the Related Art

Point of Sale (POS) terminals of the type typically used by merchants permit holders of charge cards, credit cards, debit cards, and the like to make electronic payments for services and merchandise quickly and easily. With the advent of stored value cards and other smart card schemes, the use of POS terminals in some form is likely to increase dramatically over the next few decades. Indeed, as the feature set of POS terminals and associated peripheral devices such as PIN entry devices/terminals increases, the use of POS terminals may largely supplant or even replace the use of cash and checks in many contexts.

All of the transactions that require the entry of a PIN necessitate that the PIN itself and any data associated with the PIN be secure and remain secure. As such, PIN entry devices utilize encryption in the form of keys to accomplish security. Additionally, PIN entry devices are designed to be tamper resistant security modules.

In order to provide a tamper resistant security module, PIN entry devices are sealed. If and when a PIN entry device is opened, all of the secure data is erased. Accordingly, a security system for electronic circuits contained within a secure POS terminal has been proposed in U.S. Pat. No. 6,646,565, as shown in FIG. 1. The POS terminal 10 comprises a display board 11, a security fence module 13 and a system board 12. A tamper detection circuit (not shown) is provided in part on the system board 12 and in part on the display board 11. When a security film connector 132 is placed between the system board 12 and the display board 11, the two portions of the tamper detection circuit on these boards are electrically connected. A security film 131 is wrapped around a security shell 135 in such a manner that one end of the security film 131 is placed on an interior surface of the security shell 135. The security film connector 132 is inserted in a connector holder 133 and is held in contact with the security film 131 by a clamping action of the connector holder 133 being inserted into the security shell 135. Similarly, the keypad connector 134 is inserted within a holder built into the security shell 135.

If the security fence module 13 is penetrated, a security response is triggered, deleting any confidential information contained within the security POS terminal 10. That is, when either the system board 12 or the display board 11 is disconnected from the security film connector 132 and the security film 131 is interrupted, the tamper detection circuit is promptly triggered.

However, the security film 131 is likely to be partially unwrapped or lifted so that an intruder can attempt to drill through the security shell 135 to disable the tamper detection circuit. Apparently, such POS terminal 10 cannot completely prevent unauthorized access to the circuitry within its interior. On the other hand, the security film 131, like a flexible circuit board, has the undesirable effect of increasing the production cost.

As a result, there is a need for a less expensive, more secure technique for preventing unauthorized access to the circuitry within a PIN entry terminal.

### SUMMARY OF THE INVENTION

An objective of the present invention is to provide a PIN entry terminal having a security system that is both more tamper resistant and less expensive than the prior art employing a flexible circuit board. Four tamper resistant boards enclosing a main board achieve this. A tamper detection circuit is through a plurality of soldering joints between the tamper resistant boards and the main board. If any tamper resistant boards are tampered with or any soldering joints are broken, the tamper detection circuit is also triggered by an interruption in the electrical connection.

To achieve the objective, the present invention discloses a PIN entry terminal having a security system. The PIN entry terminal comprises an interface board, tamper resistant boards and a main board. The tamper resistant boards tightly enclose the main board and are arranged like walls. There is a plurality of solder joints between each adjacent two of the tamper resistant boards and the main board. Furthermore, an electrical connector electrically connects and is placed between the interface board and the main board. A tamper detection circuit through the solder joints and the electrical connector is provided in part on the tamper resistant boards, in part on the interface board and in part on the main board. If either the interface board or the main board is disconnected from the electrical connector or one of the tamper resistant boards is tampered with, the tamper detection circuit is triggered.

### BRIEF DESCRIPTION OF THE DRAWINGS

The invention will be described according to the appended drawings in which:

FIG. 1 is an exploded diagram of a POS terminal disclosed in U.S. Pat. No. 6,646,565;

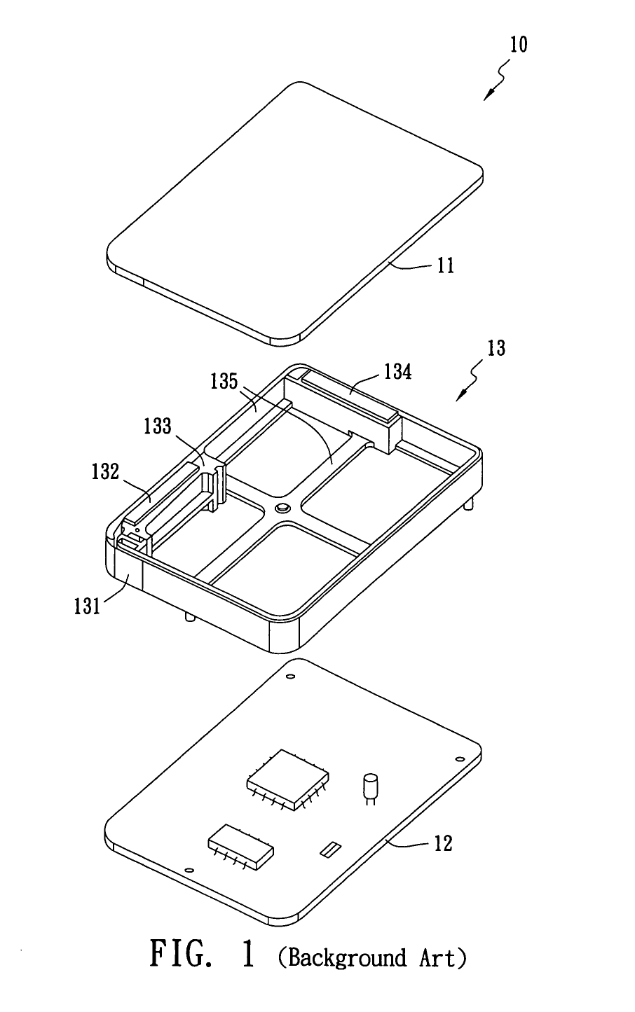

FIG. 2 is a perspective diagram of a PIN entry terminal in accordance with the present invention;

FIG. 3 is an exploded diagram of the PIN entry terminal without housings in FIG. 2;

FIG. 4(a) is a perspective diagram of the combination of tamper resistant boards and a main board in accordance with the present invention;

FIG. 4(b) is a perspective diagram of the interface board in FIG. 2;

FIG. 5 is an enlarged diagram of the portion A in FIG. 4;

FIGS. 6(a)-6(e) are plane views especially showing soldering pads of the tamper resistant boards and the main board; and

FIG. 7 is a diagram showing a grid circuit having fence-like lead wires provided on the tamper resistant board.

### PREFERRED EMBODIMENT OF THE PRESENT INVENTION

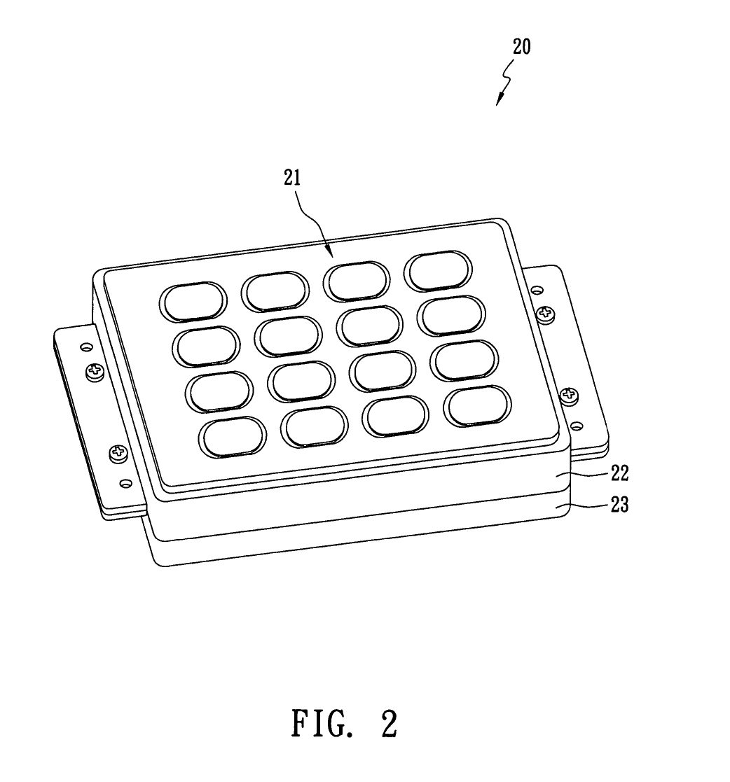

FIG. 2 is a perspective diagram of a PIN entry terminal in accordance with the present invention. The PIN entry terminal 20 comprises a keypad 21, a front housing 22 and a rear housing 23 that are firmly screwed together. To perform a payment transaction, a user of the PIN entry terminal 20 should slide a card through a card reader (not shown) first, and he can then enter a security verification code or a PIN number by the keypad 21 according to displayed transaction information.

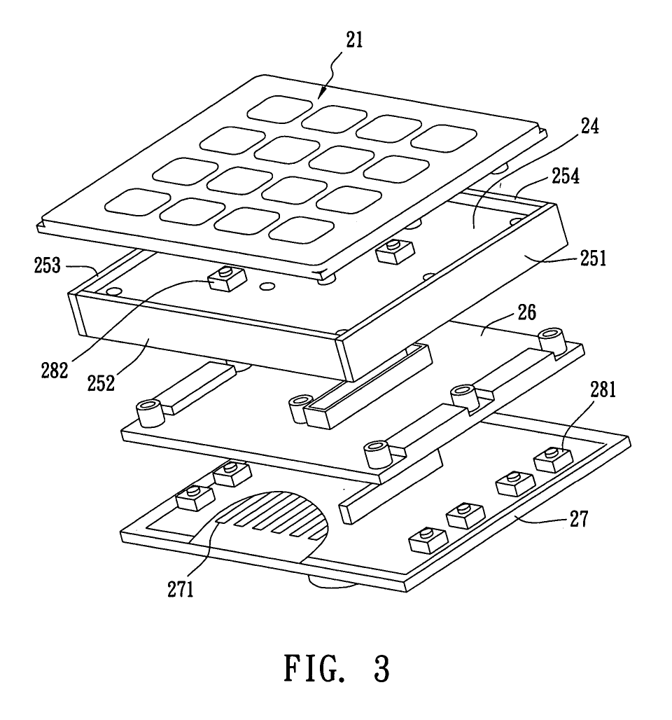

After disassembly, the keypad 21, a main board 24, tamper resistant boards 251-254, a partition 26, tamper switches 281 and an interface board 27 are clearly exposed in FIG. 3. The tamper switches 281 mounted on the interface board 27 are forcedly pressed against the partition 26 when the PIN entry terminal 20 functions well. If an intruder attempts to separate the interface board 27 from the others, the tamper switches 281 are rapidly triggered to make a tamper detection circuit give a secure response that deletes any confidential information stored in the main board 24. The tamper detection circuit is provided in part on the tamper resistant boards 251-254, in part on the main board 24 and in part on the interface board 27. If the intruder attempts to drill or cut the interface board 27 to access the confidential information, a grid circuit 271 interposed in the middle layer of the interface board 27 can detect any further penetration damage. The grid circuit has fence-like lead wires capable of deterring the intruder from trying to partially damage the interface board 27.

Furthermore, the partition 26 can be replaced by a plurality of short columns separately inserted between the tamper switches 281 and the main board 24.

Similarly, there are several tamper switches 282 provided on the main board 24 to prevent the keypad 21 from being stealthily pried open.

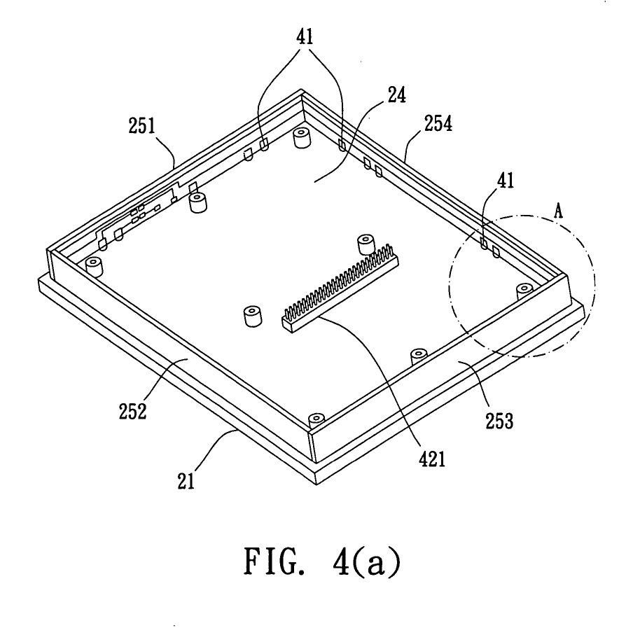

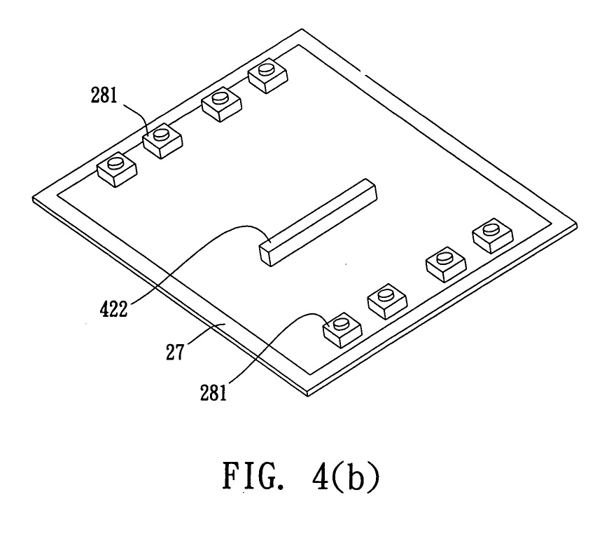

FIG. 4(a) is a perspective diagram of the combination of tamper resistant boards and a main board in accordance with the present invention. The tamper resistant boards 251-254 arranged like walls tightly enclose the main board 24. There is a plurality of solder joints 41 between each adjacent two of the tamper resistant boards 251-254 and the main board 24. Additionally, an electrical connector electrically connects and is placed between the main board 24 and the interface board 27. The tamper detection circuit is through the solder joints 41 to trace any undesired disconnection between the tamper resistant boards 251-254 and the main board 24. That is, if any of the solder joints 41 is broken by unexpected external force, the tamper detection circuit is triggered to have the secure response.

Referring to FIGS. 4(a) and 4(b), an electrical connector including a male connector 421 and a female connector 422 electrically connects and is placed between the main board 24 and the interface board 27. If either the main board 24 or the interface board 27 is disconnected from the electrical connector or one of the tamper resistant boards 251-254 is tampered with, the tamper detection circuit is also triggered.

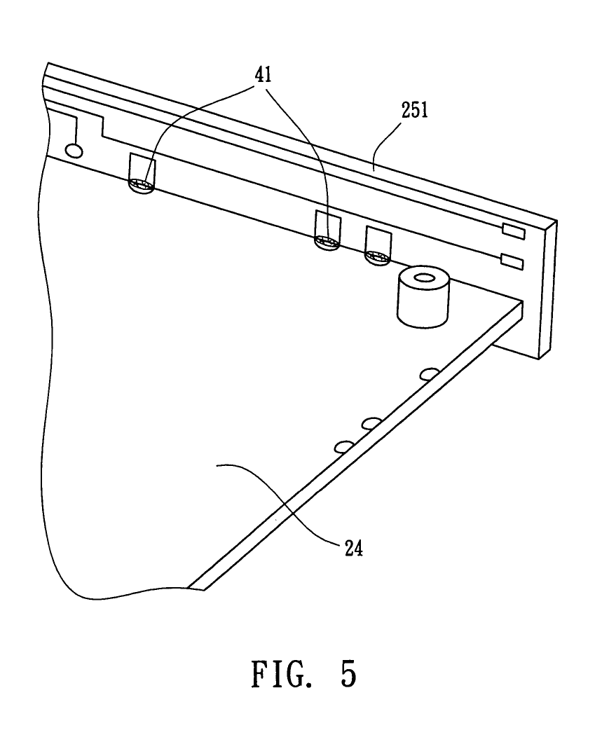

FIG. 5 is an enlarged diagram of portion A in FIG. 4(a). The solder joints 41 connect the main board 24 with the tamper resistant board 251 to form a portion of a closed and secure circuit loop of the tamper detection circuit.

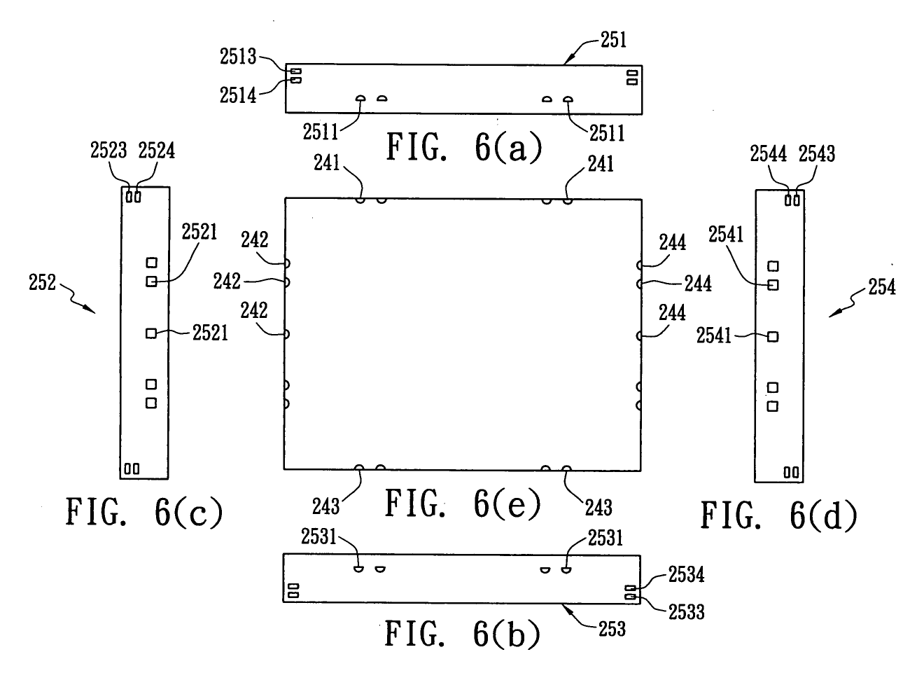

As shown in FIGS. 6(a)-6(e), there is a plurality of pairs of solder pads for the solder joints 41 to solder them together. The solder pads 2511, 2521, 2531 and 2541 are separately joined to the solder pads 241, 242, 243 and 244 by soldering. Furthermore, each adjacent two of the solder pads 2514, 2524, 2534 and 2544 are soldered together to form a portion of the circuit loop sequentially through the tamper resistant boards 251-254. The secure circuit loop powered by either the power supply of the automatic transaction machine or a backup battery set serially connects all the solder pads. Grounded pads 2513, 2523, 2533 and 2543 are also looped together by soldering as a grounded loop which is connected to ground. If the intruder injects an electrically conductive substance into the clearance between the tamper resistant boards 251-254 to bridge two lead wires of the secure circuit loop, the conductive substance will overlay one of the grounded pads 2513, 2523, 2533 and 2543 first and short-circuit the secure circuit loop with the grounded loop. When the short occurs, the accordingly secure response is immediately made.

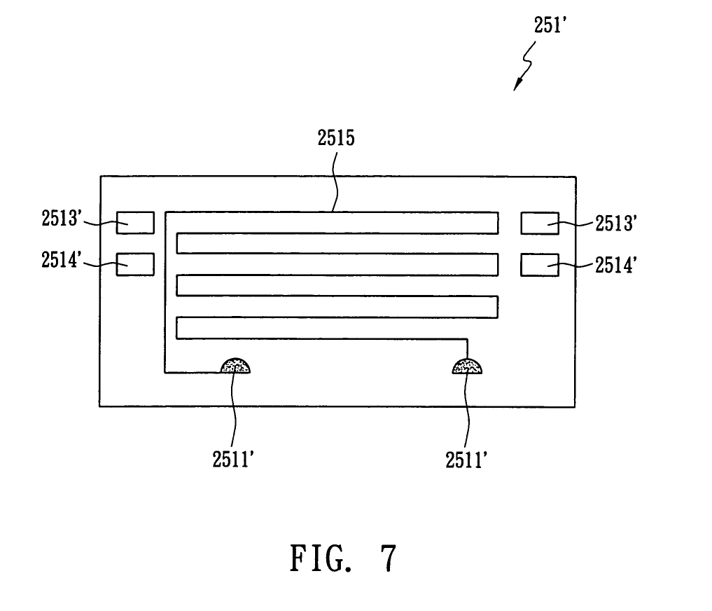

FIG. 7 is a diagram showing a grid circuit having fence-like lead wires provided on the tamper resistant board. Fence-like lead wires 2515 serially connect two solder pads 2511′. When the intruder drills into the tamper resistant board 251′, at least one of the lead wires 2515 is broken so that the two solder pads 2511′ are open. Accordingly, in response to the open secure circuit loop, any confidential information is erased. The other two solder pads 2514′ are also strung together by some lead wires (not shown). On the tamper resistant board 251′, there are two grounded pads 2513′ responding to any injection of liquid conductive material.

The above-described embodiments of the present invention are intended to be illustrative only. Numerous alternative embodiments may be devised by persons skilled in the art without departing from the scope of the following claims.

What is claimed is:

1. A PIN entry terminal having a security system, comprising:
a plurality of tamper resistant boards arranged like walls and soldered to each other by at least one first solder joint, each of the tamper resistant boards having at least one first grid circuit connected to the first solder joint;
a main board enclosed by the tamper resistant boards and connected to each of the tamper resistant boards by at least one second solder joint;
an interface board connected to the main board by an electrical connector and having at least one second grid circuit connected to the second solder joints; and
a tamper detection circuit detecting whether the electrical connector is disconnected or an open circuit occurs in the first solder joints, the second solder joints, the first grid circuit and the second grid circuit.

2. The PIN entry terminal having a security system of claim 1, further comprising a plurality of first tamper switches mounted on the interface board, triggered to make the tamper detection circuit give a secure response when the interface board is moved away from the main board.

3. The PIN entry terminal having a security system of claim 2, further comprising a partition placed between the main board and the interface board to put the first tamper switches in a non-trigger state.

4. The PIN entry terminal having a security system of claim 1, further comprising a keypad, wherein the keypad is placed over the main board and against the sides of the tamper resistant boards.

5. The PIN entry terminal having a security system of claim 4, further comprising a plurality of second tamper switches mounted on the main board, forcedly pressed against the keypad in a non-trigger state.

6. The PIN entry terminal having a security system of claim 1, wherein each of the tamper resistant boards further comprises at least one grounded pad connected to ground.

7. The PIN entry terminal having a security system of claim 6, wherein the tamper detection circuit makes a secure response when the grounded pad is shorted to either one of the first solder joints or one of the second solder joints by conductive material.

8. The PIN entry terminal having a security system of claim 1, wherein the tamper detection circuit deletes confidential information stored in the main board when the electrical connector is disconnected or an open circuit occurs in the first solder joints, the second solder joints, the first grid circuit and the second grid circuit.

9. The PIN entry terminal having a security system of claim 1, wherein either the first grid circuit or the second grid circuit has a plurality of lead wires arranged like a fence.

10. The PIN entry terminal having a security system of claim 9, wherein the tamper detection circuit deletes confidential information stored in the main board when one of the lead wires is broken.
